(19) United States
(12) Patent Application Publication
(10) Pub. No.: US 2007/0112700 A1
(43) Pub. Date: May 17, 2007

(54) OPEN CONTROL SYSTEM ARCHITECTURE FOR MOBILE AUTONOMOUS SYSTEMS

(75) Inventors: Albert Den Haan, Ottawa, ON (CA); Franco Ballotta, Lasalle, QC (CA)

Correspondence Address: OGILVY RENAULT LLP, 1981 MCGILL COLLEGE AVENUE, SUITE 1600, MONTREAL, QC, H3A2Y3, CA

(73) Assignee: FRONTLINE ROBOTICS INC., Ottawa, ON (CA)

(21) Appl. No.: 11/551,759

(22) Filed: Oct. 23, 2006

Related U.S. Application Data
(63) Continuation of application No. PCT/CA05/00605, filed on Apr. 22, 2005.
(60) Provisional application No. 60/564,224, filed on Apr. 22, 2004.

(51) Int. Cl. G06F 15/18

(52) U.S. Cl. 706/14

(57) ABSTRACT

A control system for a mobile autonomous system. The control system comprises a generic controller platform including: at least one microprocessor; and a computer readable medium storing software implementing at least core functionality for controlling autonomous system. One or more user-definable libraries adapted to link to the generic controller platform so as to instantiate a machine node capable of exhibiting desired behaviours of the mobile autonomous system.

### CROSS-REFERENCE TO RELATED APPLICATIONS

This application is a continuation application of International PCT Application Serial No. PCT/CA2005/000605 filed Apr. 22, 2005 which claims priority from U.S. application Ser. No. 60/564,224, entitled MOBILE AUTONOMOUS SYSTEMS, and filed on Apr. 22, 2004.

### MICROFICHE APPENDIX

Not Applicable.

### TECHNICAL FIELD

The present invention relates to autonomous and semi-autonomous robotic systems, and in particular to a control system for mobile autonomous systems.

### BACKGROUND OF THE INVENTION

Control systems for autonomous robotic systems are well known in the prior art. Broadly stated, such control systems typically comprise an input interface for receiving sensor input; one or more microprocessors operating under software control to analyse the sensor input and determine actions to be taken, and an output interface for outputting commands for controlling peripheral devices (e.g. servos, drive motors, solenoids etc.) for executing the selected action(s).

Within this framework, highly sophisticated robotic behaviours are possible. For example, a wide range of different sensors are available, providing a multitude of sensor input information, including, for example: position of articulated elements (e.g. an arm), Global Positioning System (GPS) location data; odometry data (i.e. dead reckoning location); directional information; proximity information; and, in more sophisticated robots, video image data. This sensor data can be analysed by a computer system (which may be composed of a network of lower-power computers) operating under highly sophisticated software to yield complex autonomous behaviours, such as, for example, navigation within a selected environment, object recognition, and interaction with humans or other robotic systems. In some cases, interaction between robotic systems is facilitated by means of radio frequency (RF) communications between the robots, using conventional RF transceivers and protocols provided for that purpose.

Typically, robot controller systems are designed based on the architecture and mission of the robot it will control. Thus, for example, a wheeled robot may be designed to use odometry for “dead reckoning” navigation. In this case, wheel encoders are typically provided to generate the odometry data, and the input interface is designed to sample this data at a predetermined sample rate. The computer system is programmed to use the sampled odometry data to estimate the location of the robot, and to calculate respective levels of each motor control signal used to control the robot's drive motor(s). The output interface is then designed to deliver the motor control signal(s) to the appropriate drive motor(s) In most cases, the computer system hardware will be selected based on the size and sophistication of the controller software, the essential criteria being that the software must execute fast enough to yield satisfactory overall performance of the robot.

While this approach is satisfactory for specialised applications (e.g. robots in an assembly plant) and laboratory systems, it does have disadvantages. In particular, the robot designer is required to be intimately familiar with the mechanical design of the robot chassis (that is, the physical hardware of the robot body, including any drive motors and/or motion actuators), the design of the controller system hardware (including input and output interfaces), the design and coding of software that will run on the controller system, and the manner in which all of these elements will interact to yield the final behaviours of the robot. This requirement for in-depth knowledge of such diverse technical fields creates an impediment to the entry of developers into the field of robotics, and inhibits the development of increasingly sophisticated robot designs.

These difficulties are compounded in cases where it is desired to deploy multiple autonomous robots that are intended to interact to achieve a common objective. In this case, in addition to all of the difficulties described above with respect to each individual robot, the designer must also become familiar with wireless communications protocols, and algorithms for coordinating the behaviours of multiple robots. This creates a severe impediment to the development of multi-robot systems which provide adaptive, predictable, coherent, safe and useful behaviours.

Accordingly, methods and systems which simplify the process of robot controller design, and facilitate the deployment of multi-robot systems, remain highly desirable.

### SUMMARY OF THE INVENTION

Accordingly, an object of the present invention is to provide a robot controller architecture that simplifies robot controller design, and facilitates the deployment of multi-robot systems.

Thus, an aspect of the present invention provides a control system for a mobile autonomous system. The control system complies a generic controller platform including: at least one microprocessor; and a computer readable medium storing software implementing at least core functionality for controlling autonomous system. One or more user-definable libraries adapted to link to the generic controller platform so as to instantiate a machine node capable of exhibiting desired behaviours of the mobile autonomous system.

Thus, the present invention provides a Robot Open Control (ROC) Architecture, which includes four major subsystems; a communications infrastructure; a cognitive/reasoning system; an executive/control system; and a Command and Control Base Station. The ROC architecture enables control of both individual robots and hierarchies of multi-robot teams, and is designed to provide adaptive, predictable, coherent, safe and useful behaviour for both autonomous vehicles and collaborative teams of autonomous vehicles in highly dynamic hostile environments. Teams are organized into a hierarchy controlled by a single Command and Control Base Station.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating principal components and message flows of a robot controller in accordance with a representative embodiment of the present invention;

FIG. 2 schematically illustrates elements and communications paths of collaborative teams of robots, in accordance with an embodiment of the present invention;

FIG. 3 schematically illustrates basic communication flows in the collaborative team of FIG. 2;

FIG. 4 schematically illustrates intra-team communication flows in the collaborative team of FIG. 2;

FIG. 5 schematically illustrates intra-team communication flows for team coordination and team-OPRS mirroring in the collaborative team of FIG. 2;

FIG. 6 schematically illustrates communication flows from the bases station to all the team members of the collaborative team of FIG. 2; and

FIG. 7 schematically illustrates a representative hierarchy of collaborative teams.

It will be noted that throughout the appended drawings, like features are identified by like reference numerals.

### DETAILED DESCRIPTION OF THE PREFERRED EMBODIMENT

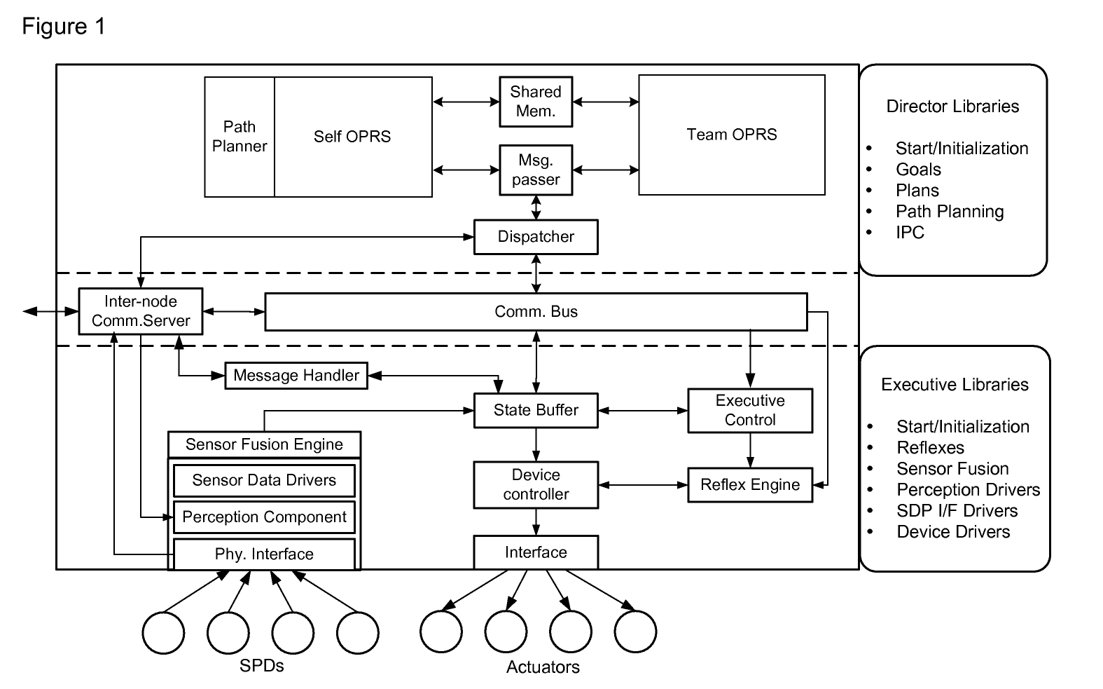

The present invention provides a Robot Open Control (ROC) Architecture which facilitates the design and implementation of autonomous robots, and cooperative teams of robots. Principal features of the ROC architecture are described below, by way of a representative embodiment, with reference to FIGS. 1-7.

As may be seen in FIG. 1, the ROC architecture generally comprises a generic controller platform 2 and a set of user-definable libraries 4. The generic controller platform 2 may be composed of any suitable combination of hardware and embedded software (i.e. firmware), and provides the core functionality for controlling an individual robot and for communicating with other members of a team of robots. In brief, individual robots (or machine nodes) are responsible for acquiring state data, processing this data into information, and then acting on the information. As such, the generic controller platform 2 provides an open “operating System” designed to support the functionality of the machine node. The user-definable libraries 4 provide a structured format for defining data components, device drivers, and software code (logic) that, when linked to the generic controller platform, instantiates a machine node (autonomous mobile system) having desired behaviours. All of these functions will be described in greater detail below.

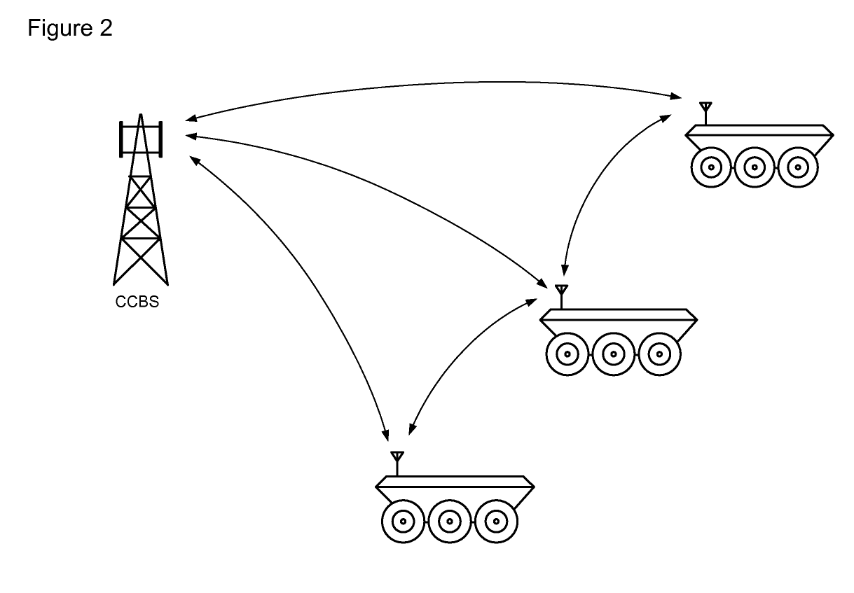

In the illustrated embodiment, the generic controller platform 2 is divided into a Director layer 6 and an Executive layer 8, which communicate with each other via a communications bus 10. An inter-node communications server 12 is connected to both the Director and Executive layers 6 and 8, to facilitate communications between the generic controller platform 2 and other robots, and with a command and control base station 14 (FIG. 2). The executive layer 8 is responsible for low-level operations of the machine node, such as, for example, receiving and processing sensor inputs, device (e.g. motor, actuator etc.) controls, reflexive actions (e.g. collision avoidance) and communicating with the Director layer. The director layer 6 provides reactive planning capabilities for the machine node, and collaborates with Director layer instances in other machine nodes. Representative functionality of the Executive and Director layers 6 and 8 is described below.

Executive Layer

The Executive Layer 8 binds together all basic low level functionality of the machine node, provides reflexive actions and controlled access to low-level resources. The Executive layer 8 preferably runs in a real-time environment.

In the illustrated embodiment, the Executive Layer 8 broadly comprises a data path and a control path. The data path includes an input interface 16 for receiving sensor data from Sensor Publishing Devices (SPDs) 18; a sensor fusion engine 20 for filtering and fusing the sensor date to derive state data representing best estimates of the state of the machine node; and a state buffer 22 for storing the state data. The state data stored in the state buffer 22 is published to the Director layer 6, and can also be poled by the communications server 12, via a message handler 24, for transmission to other machine nodes and/or the command and control base station 14.

The control path includes an Executive controller 26, which receives director commands from the Director layer 6. As will be described in greater detail below, these director commands convey information concerning high-level actions to be taken by the machine node. The Executive controller 26 integrates this information with state data from the state buffer 22, and computes low-level actions to be taken by the machine node. The associated low-level action commands are then passed to a reflex engine 28, which uses bit-map information (e.g. allowed operating perimeter, static obstacles, dynamic and unknown objects) to modify the low-level action commands as needed to ensure safe operation. The resulting action commands are then passed to a device controller 30 which generates corresponding control signals for each of the machine node actuators 32 (e.g. motors, servos, solenoids etc.).

Sensor Publishing Devices (SPDs)

A Sensor Publishing Device (SPD) 18 is a process bound to one or more sensors (not shown). The SPD 18 acquires data from the sensor(s) and passes that data to the Executive layer 8 using a predetermined messaging protocol. This arrangement facilitates modular development of arbitrarily complex sensor constellations.

Input Interface

The input interface 16 includes a physical interface 34, such as a serial port, coupled to logical processes for device drivers 36 and sensor perception 38. The device drivers 36 are user-defined software libraries for controlling the various SPDs. The perception component 38 extracts the sensor data from the SPD messaging, for further processing by the sensor fusion engine 20.

Sensor Fusion Engine

The fusion engine 20 receives sensor data from the input interface 16, and reshapes this information to improve both the reliability and usability of the sensor data for other elements of the system (e.g. Director Layer functionality, Executive controller 26, and remote nodes such as other machine node instances and the command and control base station 14).

Various data shaping strategies may be employed, depending on the senor configuration and mission of the autonomous system. In order to support maximum flexibility, the data shaping logic is provided by user defined Sensor Fusion libraries. Representative data shaping functions are described blow, for the case of a wheeled robot having the sensor publishing devices associated with each of the following:
Gyro-enhanced orientation sensor;
Global Positioning System (GPS) receiver;
Wheel encoders; and
Laser-based range finder (LMS)

The orientation sensor, GPS and wheel encoder data is continuously used for determining the vehicle position and providing position feedback to control modules while moving along a geographically reference path. The range finder data is used for obstacle avoidance and gate navigation. In this example, the user-defined sensor fusion libraries are divided into four sub-modules; Pre-filtering/Diagnostics, Filtering, Obstacle Detection and Gate Recognition.

The Pre-filtering/Diagnostics sub-module deals with the raw sensor data from different sensors, and compares them against each other in order to obtain more reliable estimates of measured parameters. This procedure is tightly related with concurrent verification of whether or not each of the sensors is working properly.

For example, if no turn commands have been issued (by the reflex engine 28) the vehicle should be moving along a straight path, and the sensor data should reflect this. Thus, wheel encoder data from left and right sides of the vehicle should be nearly equal; GPS data should indicate consecutive points lying on a straight line; and orientation sensor data should be approximately constant. If these four groups of data (i.e. commands, wheel encoders, GPS, orientation) are all consistent, then the situation is normal, and all available sensor data information can be passed to the Filtering sub-module. If, on the other hand, one of the data groups contradicts the others, then various diagnostics modules can be triggered to identify which data group is in error, and to diagnose the problem (e.g. wheel slippage occurs, GPS not working, orientation sensor not working, vehicle brakes are locked on one side etc.). Errored sensor data can be discarded, and appropriate fault notification messages published to the Director layer 6 and sent to the command and control base station 14.

“Cleaned” sensor data generated by the Pre-filtering/Diagnostics sub-module are then be passed to the Filtering sub-module, which may implement a Kalman filter type algorithm that provides optimal (in a statistical sense) estimates of the vehicle position and motion.

The Obstacle Detection sub-module primarily relies on range data provided by the Laser-base range finder (LMS). In the present example, the LMS is used for continuously checking the area in front of the vehicle. Any objects detected within the visibility range of the LMS are tracked and examined to detect when the object enters a predefined “avoidance zone”. Objects within the avoidance zone are classified according their azimuth and range, and reported to an Obstacle Avoidance reflex described in greater detail below. The Obstacle Avoidance reflex generates instructions (to the reflex engine 28) for executing an appropriate manoeuvre to avoid the obstacle. Objects within the avoidance zone are also monitored and further examined for entering a predetermined “stopping zone”. When this occurs, the Obstacle Avoidance reflex triggers a vehicle stop command to the Device Controller 30.

Continuous monitoring of the area in front of the vehicle can be based on a clusterization algorithm for processing data provided by LMS. This data consists of an array of ranges corresponding to a predetermined scan sector (e.g. a 180° sector in 0.5 deg increments). A representative clusterization algorithm consists of following steps:
(i) Filter out isolated points corresponding to sensor noise or too small objects
(ii) Determine those groups of consecutive points without substantial jumps, each group being substantially separated from each other; those groups constitute clusters or objects.
(iii) Determine for each group (object) minimal and maximal azimuth, and average range; this information is used for monitoring object evolution relative to the sensor (corresponding in reality to the sensor motion relative to objects).

This algorithm constitutes the main processing step providing information to the Obstacle Avoidance reflex as well as an input to the Gate Recognition sub-module.

The Gate Recognition sub-module uses the obstacle information provided by the Obstacle Detection sub-module to find a pair of objects of known shape (i.e. posts) which together define a “gate” through which the vehicle is required to go. A representative algorithm for the gate recognition sub-module consists of following steps:
(i) All pairs of objects detected by the clusterization algorithm are examined in order to find pairs of objects of appropriate size and separated by an appropriate distance (within a predetermined tolerance).
(ii) All pairs that have met step 1 conditions (if any) are examined to identify an object pair that is closest to an expected geographical location and orientation of the gate. This expectation may be based on world model information provided by the Director layer 6.
(iii) A “gate signature” is then calculated for the identified object pair. The “gate signature” captures essential aspects of the gate shape and, at the same time, is related to the point of view from which the gate is seen.

In one embodiment, calculation of the gate signature uses the following components extracted from LMS data corresponding to the pair of previously identified objects: overall size (e.g. width) of the gate, size (i.e. width) of the entrance; sizes of distinguishable fragments of each post (e.g. straight line segments, for the case of rectangular posts). These components are ordered (e.g. from right to left) and combined into a vector by assigning a negative value to the entrance size, and positive values to other components. For example, consider the case of a robot viewing (approaching) a gate from one side. The gate consists of two (1 m×1 m) square posts separated from each other by a gap (forming the entrance) of 5.1 m. For this case, the signature is a 6-dimensional vector [1, 1, −5.1, 1, 1, 7.1]. The Signature depends not only on the gate shape but also on the vehicle location with respect to the gate. Moreover, both signature component values and vector dimensions may be affected by changes in vehicle position. For example, for a robot vehicle located straight in front of one post, the gate signature becomes a 5-dimensional vector [1, −5, 1, 1, 1, 7.1].

In one embodiment, a database of possible gate signatures is prepared by pre-computing gate signatures for different possible positions around the gate, according to a gate visibility graph. With this arrangement, successive gate signatures (calculated as described above) can be compared against the pre-computed gate signatures to find a best fit match (e.g. by minimizing the norm of the difference between 2 signatures). The best fit pre-computed signature can be used first to determine (and monitor continuously) the location of the gate reference points, and then to deduce the position/orientation of the gate with respect to the vehicle. This information is output by the gate recognition module and used by the gate crossing reflex, described below.

Executive Controller

As mentioned above, the Executive controller 26 receives director commands, and uses this information to derive action commands for triggering low-level actions by the machine node. In order to provide maximum functionality, the Executive controller logic is provided by way of user-defined libraries constituting reflexes of the reflex engine 28. Three representative algorithms (reflexes) are described below, each of which corresponds to a respective motion mode, namely, way-point navigation mode, obstacle avoidance mode, and gate crossing mode.

A Way-point navigation reflex can, for example, be implemented using a multi-level algorithm having several levels. For example:
A Higher level reflex verifies that a current segment (i.e. from W-Point_from to W_Point_to) has expired, then loads geographical coordinates of the next way-point from a “path description list” (provided by the Director layer 6) and makes appropriate updates. The decision about the expiration of the current segment can be made using the length of the segment and the distance run by the vehicle (which may, for example, be estimated in the fusion engine using GPS and odometry information. In case of getting to the last point in the “path description list”, a “vehicle stop” command is triggered, and the Executive controller 26 waits for further Director commands. The “path description list” can be continuously updated by the director layer 6.
An Intermediate level reflex provides a state machine deciding first for the necessity of a “consistent turn” (e.g. nearby a way-point) depending on the angle between two consecutive path segments and the current vehicle orientation (which may be derived from INS data and/or estimated by the fusion engine 20); and next managing the angle of approach to the new segment depending on the current lateral/heading offset from the segment.
A Low level is a feedback controller sharing some characteristics with fuzzy logic type controllers. It generates corrective signals to turn the vehicle depending on the current estimations of the lateral/heading offsets from the segment to be followed, which are obtained from the fusion engine 20 based on GPS, INS, and odometry data.

An Obstacle Avoidance reflex provides an actuation counterpart to the obstacle detection sub-module described above. It is preferably designed as a fast, simple, reactive algorithm that can consistently guarantee the safe navigation in the presence of unknown obstacles. A representative algorithm can function as follows:
(i) If any objects are detected within the avoidance zone, the closest object becomes an active obstacle. The Avoidance controller generates an appropriate manoeuvre, and overwrites the steering commands generated by the Way-point navigation reflex thus forcing the vehicle to leave the path it was executing. Once the active obstacle has moved outside of the Avoidance zone, the Obstacle Avoidance reflex allows control to return to the Way-point navigation reflex so that the machine node returns to its original path. The Avoidance zone is defined as a region within predefined azimuth and range limits in front of the vehicle (e.g. ±45 deg and 3 m-7 m).
(ii) If any objects are detected within the Stopping zone, the Avoidance controller generates a “vehicle Stop command. This situation occurs only if an avoiding manoeuvre was not successful. The Stopping zone is defined as a region within a predefined azimuth and range limits in front of the vehicle (e.g. ±180 deg and 1 m-3 m).

Gate crossing reflex provides an actuation counterpart to the Gate Recognition sub-module described above. This reflex uses the position and orientation of the gate relative to the vehicle, as obtained from LMS data by the gate-signature-based methodology described above, to actively steer the machine node through a gate. In one embodiment, the gate-grossing algorithm outputs real time vehicle steering instructions in a close-loop to achieve the desired position/orientation of the vehicle; that is, in front of the gate mid-point, and oriented perpendicularly to the gate entrance. This desired vehicle position/orientation is called a Target point, which is then advanced through the gate at a near constant speed close to the estimated vehicle speed, thereby progressively guiding the machine node (vehicle) through the gate.

If desired, the obstacle avoidance sub-module may be active during the “gate crossing” manoeuvre, but in this case its parameters (that is, the size of the avoidance and stopping zones) are adjusted in order to prevent undesired initiation of an avoidance maneuver around the gate or vehicle stop command.

Director Layer

The Director Layer 6 is a cognitive layer that performs high level reactive planning, and decides what actions are to be executed. This layer preferably contains multiple reasoning engines and a regulator mechanism that allows dynamic apportioning of machine resources among these engines.

In the illustrated embodiment, the Director Layer 6 maintains two cognitive planning engines (OPRSs) 40, 42—one for team behaviours and one for self-behaviours. Each OPRS maintains; a world model of facts pertinent to it's role; a set of goals; and a body of domain-specific knowledge in the form of a plan library. Each of these elements may be provided by user defined libraries and/or updated during run-time on the basis of state data received from the Executive Layer 8 and inter-node messaging from other machine nodes (robots) and the command and control base station 14.

The OPRSs 40, 42 solve problems in different domains: the team-OPRS 42 is concerned with team strategy and tactical coordination of individual robots; the self-OPRS 40 is concerned with path trajectory-planning and immediate self-behaviours. Both OPRSs 40, 42 communicate with each other via the communications bus 10 (e.g. using a local socket-based messaging protocol). They can also communicate with other nodes via the communications server 12. The target of team-OPRS communications is another OPRS instance (i.e., an OPRS of another machine node). The target of self-OPRS communications can be another OPRS instance or the local Executive Layer 8.

In the illustrated embodiment, the Director Layer 6 uses a dispatcher 44 to manage communications. In particular, the dispatcher 44 performs message addressing and scheduling for:
communications between each OPRS 40 42 and with Director layer 6 processes;
communications with the local Executive Layer 8;
communications with other nodes (via the communications server 12); and
message routing between any of the above components.

In addition, the dispatcher 44 can be used to perform:
predefined action(s) on receipt of a message from any particular source (e.g. based on message type or message header information);
monitoring organizational structure and heartbeat messages. (described below) The Dispatcher 44 can also react to changes in team structure (for example, to determine changes in leadership or relink a child team to a new parent), as will be described in greater detail below;
automatically switch between plural communications servers (if favourable) on a detected loss of connection;
dynamically subscribe, define and publish different messages based on changes in organizational structure; and
initiate scheduled inter-node communications (for instance, position updates and unexpected object reports).

Preferably, the dispatcher 44 maintains a registry containing information identifying it's self_id, it's team_id, the ids of all it's team members, and it's parent and child nodes in a hierarchy. Based on this information, the dispatcher 44 can register/subscribe to all appropriate messages/groups on, for example, either a network of IPC servers or a Spread message bus. If the underlying communication service does not provide fault tolerance, the dispatcher 44 can monitor the current communication server connection and switch to new servers on connection loss. Finally, the dispatcher 44 can update the OPRS world models, as appropriate, based on state data received from the local Executive Layer 8, and inter-node messaging received from other nodes.

In a representative embodiment, the dispatcher 44 reads a number of configuration files at system start-up. For example:
a defaults file can be used to specify which files/libraries should be used to initialize the director layer 6;
a “node” file defining the robot's name and describing the node's (that is, the robot's) description and capabilities. This information is passed to the OPRSs 40, 42;
a “network” file defining hierarchy organization (robots, & teams) and communications interfaces;
a “routing” filed defining message routing rules based on message content and source;
a “tours” file defining predefined movement plans;
a “map” file describing a geographical area of operation and identifying choke-points, etc.
a “self” file defining the source file to be used to initialize the self OPRS 40;
a “team” file defining the source file to be used to initialize the team OPRS 42. All team OPRSs on the same team share the same set of goals and plans.
   Intra-node Communications

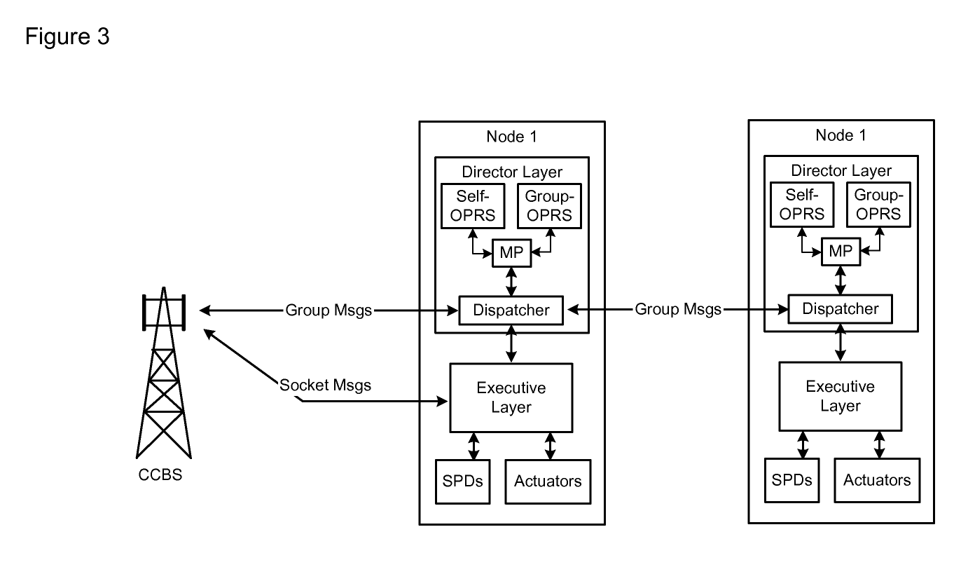

The system of the present invention preferably distinguishes between intra-node and inter-node communications. Intra-node communications are used to share information between processes running on a single machine node. Inter-node communications supports collaboration between machine nodes. FIGS. 2 and 3 illustrates basic communication flows.

Referring to FIG. 3, the vertical messaging flows are intra-nodal. The horizontal flows are inter-nodal. Intra-nodal communications are high frequency messages using the local high-speed communications bus 10, which may, for example, be provided as a combination of shared memory, socket connections and named pipes. Inter-nodal communications are mediated by wireless links 46 (FIG. 2), and thus occurs at a lower rate, and is typically less reliable.

Shared Memory Segments can be used advantageously for communications between Director and Executive layers 6 and 8. Each memory segment preferably consists of a time-stamp and a number of topic-specific structures. Each topic-specific structure contains a time-stamp and pertinent data fields. Access to the shared memory segments is controlled by semaphores. When writing to a shared memory segment the writer may perform the following steps:
(i) Acquire access to the segment;
(ii) For each structure to be updated; update the data in the structure, then set the structure's time-stamp to the current time;
(iii) Set the segment time-stamp to the current time; and
(iv) Release the segment.

When reading a shared memory segment the reader performs the following steps:
(i) Acquire access to the segment;
(ii) Check is the time-stamp is set. If so continue to the next point, otherwise release the segment;
(iii) For each topic-specific structure in the segment, check the time-stamp. If the time-stamp is set read the structures data then set the structure time-stamp to zero;
(iv) Set the segment time-stamp to zero; and
(v) Release the segment.

Four shared memory segments are used in the illustrated embodiment: the ROCE_DATA_SEGMENT, the ROCE_COMMAND_SEGMENT, the PRS_SEGMENT, and the BITMAP SEGMENT.

Roce Data Segment

The Executive layer 8 is the sole writer to this segment. The dispatcher 44 is the sole reader of this segment. This segment is used to communicate state data (pose, intruders, etc.) between the Executive and Director layers.

Roce Command Segment

The dispatcher 44 and SELF-OPRS 40 agent are the two writers to this segment. The Executive Layer 8 is the sole reader of this segment. This segment is used to issue Director commands to the Executive Layer.

PRS Segment

The dispatcher 44, SELF-OPRS 40 and TEAM-OPRS 42 are the writers and readers of this segment. This segment has two purposes. Firstly, it is used by the OPRSs 40 and 42 to pass statistical data to the dispatcher 44. The dispatcher 44 uses this data to monitor OPRS health. Secondly, it provides a mechanism whereby the dispatcher 44 can disable OPRS plan execution. For example, the OPRSs 40 and 42 can be programmed to check for an execution flag in the PRS_SEGMENT. If this flag is set, each OPRS interpreter continues normally. If the flag is not set, the interpreter performs all database update activities, but suspends intending and execution activities. This ensures the OPRSs maintain current world models even when they are idle.

Bitmap Segment

The dispatcher 44 is the sole writer to this segment. The Executive Layer 8 is the sole reader of this segment. This segment contains a number of bitmaps. A bitmap is a two dimensional array of bits where each bit represents a fixed size area. The bitmaps are used to efficiently map features or properties of a geographical operating area (or part thereof) against locations.

Director Layer processes (e.g. the Dispatcher 44, OPRSs 40, 42 and a STRIPS planner) preferably communicate using a socket-based message passing server. This mechanism provides point-to-point communications and the flexibility to easily incorporate new processes.

Name pipes are preferably used in situations where is it useful to insert filters into the data flow. This is beneficial in sensor data processing.

Teams

Organizational Model

Every machine node (robot) is a member of a team. Teams are groupings of 1 to N robots. FIG. 2 schematically shows two teams 48 of three member robots each. At any instant, each team has exactly one leader 50. Team leadership can change dynamically and every team member is capable of assuming the leader role. Team members always know the identity their team leader. Team leaders coordinate team member activities to achieve specific goals. They do this by monitoring team activity and issuing directives to team members. These directives are team goals.

Team members have individual directives, referred to herein as self-goals. Each member is responsible for satisfying its own self-goals and any assigned team-goals. Individual robots select appropriate behaviours after reviewing their current situation and their list of goals and associated priorities. Team directives add new goals to a robot's goal list. Because team goals generally have a higher priority than self-goals, individual robots dynamically modify their behaviour to support team directives, and then revert to self behaviours when all team goals have been accomplished. Teams may also share a “hive mind” where world model information is communicated between team members. This greatly enhances each team member's world view and it's ability to make good decisions.

Preferably, teams 50 are organized into a hierarchy. A parent team coordinates activity between its immediate child teams. This coordination is accomplished via communications by respective team leaders. Directives flow from the top of the hierarchy to the bottom: directives are issued by parent teams and executed by child teams. Operation data flows from the bottom of the hierarchy to the top: members report to team leaders; child team leaders report to parent team leaders.

A single base/command station 14 can monitor and control a hierarchy of robot teams. The base station can “plug into” any part of the hierarchy, monitor operations and issue directive. It can also address a single machine node if needed.

Intra-team communications are communications between machine nodes (robots) within a single team 48. There are two classes of intra-team communications: data sharing; and team coordination. All machine nodes participate in data sharing. This supports the team “hive mind”. An example of this functionality is that of mobile robots sending current position updates to their teammates on a regular basis. For a team of N robots this results in N data sources pushing data to N-1 data targets. Team coordination is the responsibility of the team leader 50. The team leader 50 will pass directives to all team members. For a team of N robots, this results in 1 data source pushing data to N-1 targets. When the team size is 1, robots do not bother with intra-team communications. A Director layer dispatcher 44 is the start and endpoint for all inter-node communications.

Preferably, rules are defined regarding inter-node communications. In one example, non-leader team dispatchers 44 can only communicate with: other team members; and the base station 14 in response to base-initiated queries (e.g. for assisted tele-operations). This rule allows modeling of bandwidth, and relating bandwidth requirements to team sizes for given applications. Note that a particular application will normally have defined message formats and policies that allow modelling of message frequencies and payloads. The segmentation of traffic between communication servers or groups supports scalability for large robot populations.

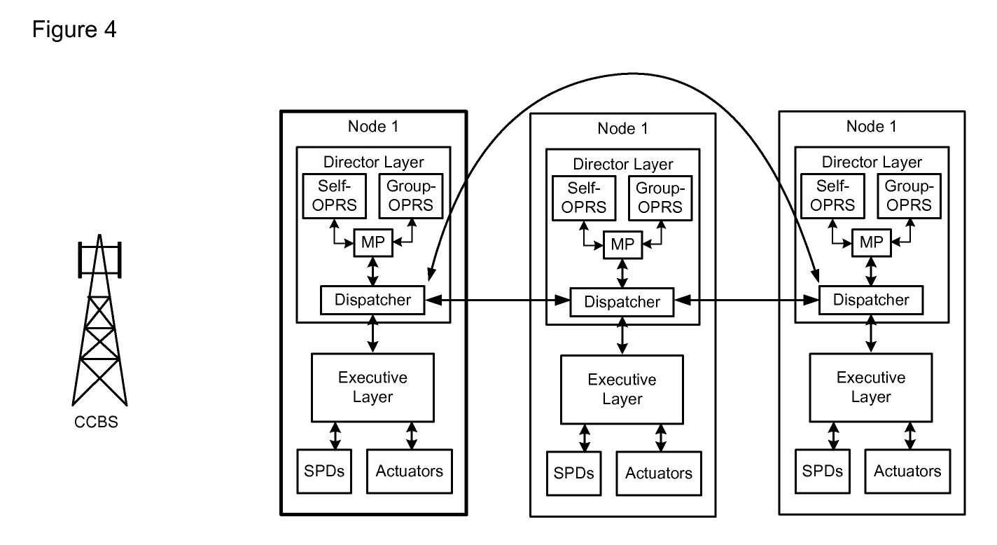

Most message traffic is expected to be between team members. In such cases, the most prevalent messages consist of world model update information (e.g. robot position, pose, self-status and intruder location, etc.). Team members may issue data sharing messages on a fixed schedule (e.g. once per second, although this is a configurable parameter). This supports the hive-mind model where every team member's world model contains all peer knowledge. Preferably, data sharing messages are only transmitted if there has been a change in the message content since the last transmission of that message type. FIG. 4 illustrates a representative data sharing mechanism.

The diagram of FIG. 4 shows the base station 14 and a team 40 of three robots (nodes 1-3). The left-most team member is the team leader 50, and is shown enclosed in a bold perimeter. The diagram shows the following features:
Each self-OPRS 40 is sending messages to its dispatcher 44, via a message-passer (MP).
Each Executive layer 8 is providing information to the local dispatcher 44, via the communications bus 10 (e.g. shared memory).
Each dispatcher 44 performs a multi-cast to all other dispatchers 44 in the team.
The dispatchers 44 receive incoming messages, then consult their rules and apply any necessary actions and routing for each message type. This usually includes routing the message to both the self- and team-OPRSs 40, 42 and the local Executive layer 8 on that node.

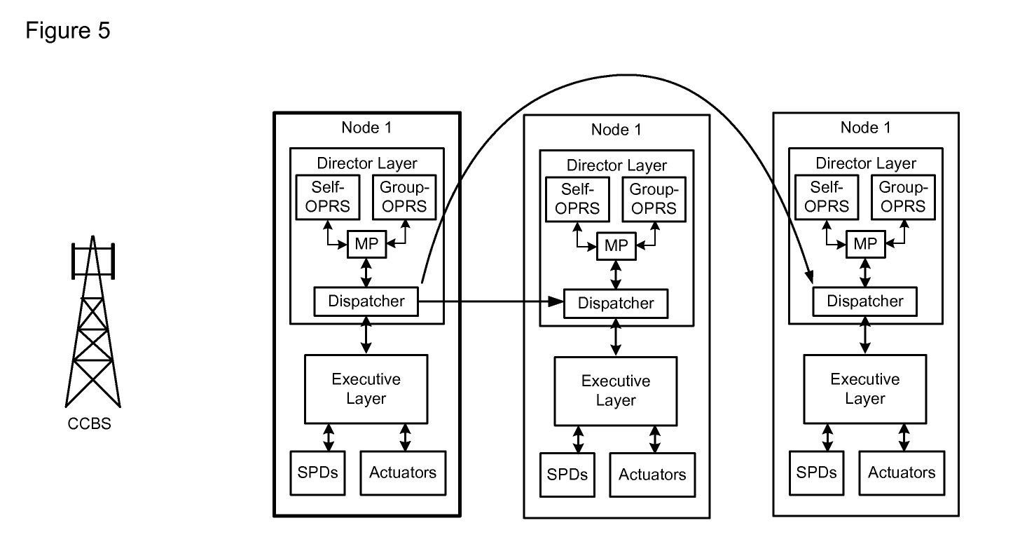

This mechanism is useful for synchronizing data between team members. FIG. 5 is concerned with team coordination and team-OPRS mirroring. This diagram is identical to FIG. 4, except is shows the flow of data from a team leader 50 to team members. Note the following features:
Only one team-OPRS 42 is issuing directives—the team leader's team-OPRS. This is a key distinction between the team leader 50 from all other team members.
The team leader's directives are sent to it's local dispatcher 44, and conditionally (if there is a directive assigned to this machine node) to the local self-OPRS 40.
The dispatcher 44 multi-casts these directives to all other dispatchers 44 in the team.
The dispatchers 44 receive incoming messages, then consult their rules and apply any necessary actions and routing for that message type. This includes routing messages to the team-OPRS 42 on that node. Optionally, if there is a directive assigned to that machine node, directives will also be sent to the local self-OPRS 40.

This mechanism ensures all team-OPRSs 42 share the same state. In embodiments in which team leadership can change dynamically this is very important. By presenting each team-OPRS with common world model data, disruptions to team activity e.g. to loss of the team leader) is minimised, and integrity in team coordination efforts is ensured.

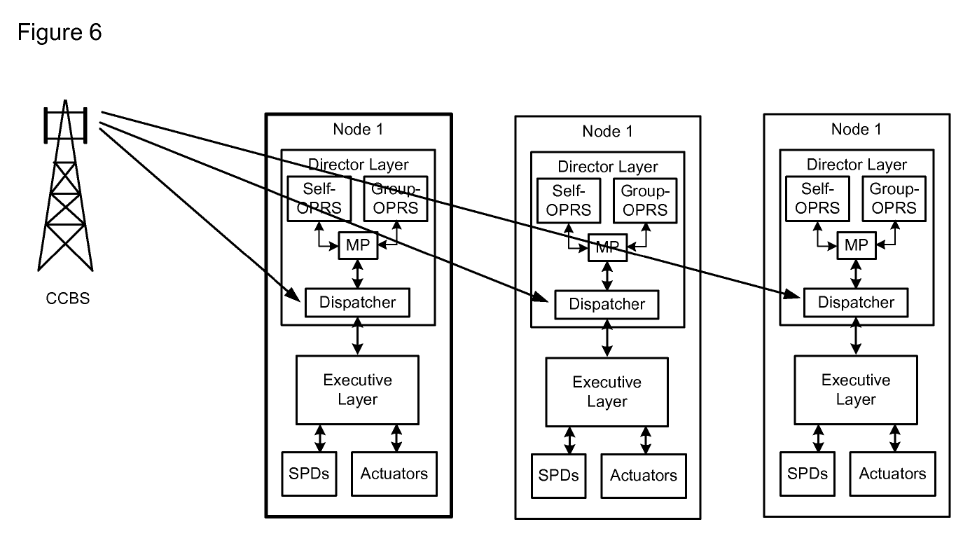

The diagram of FIG. 6 shows representative message flow of data from an external source (the base station) to all of the team members. Note the following features:
The base station 14 communications are directed to the whole team, rather than any particular machine node (in fact, it is a multi-cast to all team members)
The dispatchers 44 in each node receive incoming messages, then consult their rules and apply any necessary actions and routing for that message type. This includes routing messages to the team-OPRS 42 on that node.
Any messages from the team 48 to an outside entity are initiated only by the team leader 50.
   Team Hierarchies

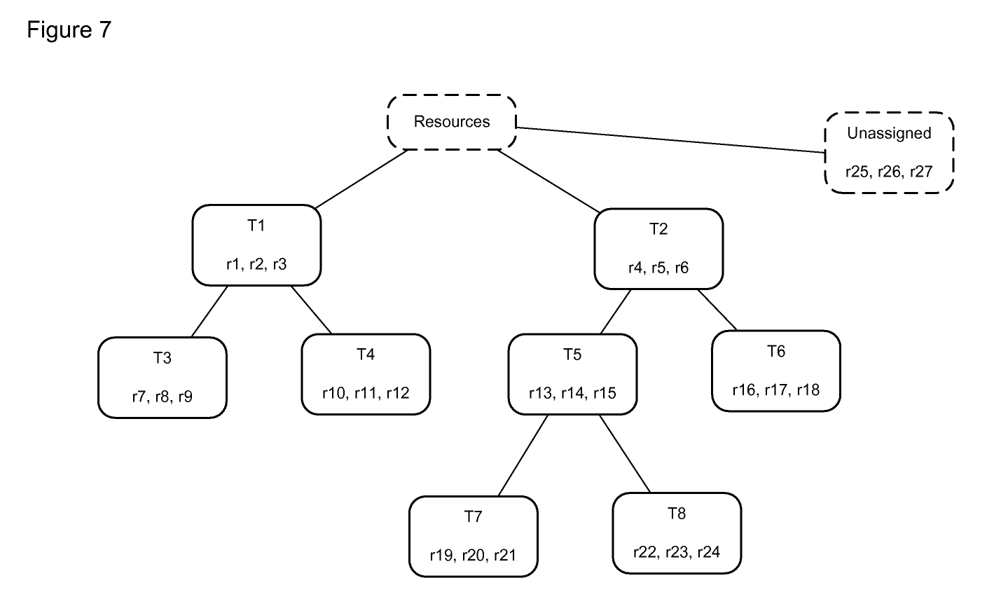

A team hierarchy can contain an arbitrary number of teams 48, each of which can have 1 to N nodes. FIG. 7 shows an example hierarchy of 8 teams 48. Each team (or hierarchy node) is represented by a rectangle with rounded corners. The first line of text in the rectangle is the team name, the lower line is a list of team member ids. For example, team T2 contains the members r4, r5 and r6.

In the illustrated embodiment, the hierarchy also contain two pseudo-nodes: “RESOURCES” 52 and “UNASSIGNED” 54. The pseudo-node RESOURCES 52 is the root of the hierarchy and does not contain any team members. Its purpose is to ensure the hierarchy can always heal itself. If, for example, robots r4, r5 and r6 were destroyed (or otherwise failed), then team T2 would cease to exist. In this case teams T5 and T6 can “heal” the hierarchy by linking themselves to T2's parent team (in this case, by linking directly to RESOURCES 52). Because a virtual entity cannot be destroyed, it is possible to ensure the hierarchy's integrity after “healing”.

The pseudo-node UNASSIGNED 54 is a staging area. All robots known to the hierarchy but not assigned to a team 48 belong to this node. The members of this team are always available for assignment to another team. The UNASSIGNED node 54 can be used to ensure integrity when moving robots from one team to another. For example, robot r1 can be moved from T1 to T2 by removing r1 from T1—this revokes r1's membership in T1 and implicitly assigns r1 to UNASSIGNED 54, then assign robot r1 to T2—this removes r1 from UNASSIGNED 54 asserts r1's membership in T2. This two-step process ensures that there will be no “loss” of robot resources when reassigning membership regardless of on-going structural changes to the hierarchy.

Inter-team communications travel through the hierarchy following the parent/child links between teams 48. The origin and destination of inter-node team communications is a team leader 50. Inter-team communications are always performed regardless of the team size or hierarchy size. This is because a Command and Control base station 14 may always monitor hierarchy activity.

In the example above team T2 can directly send messages to team T5 and team T6. Team T2 cannot directly send messages to team T3 or team T4. However, the base station 14 may monitory messages at the top of the hierarchy an thus can issue directives to T1 based on T2's information. Team T1 (that is, T1's team leader) can decide if the information is pertinent to teams T3 and T4 and may forward that message, or a portion of it, to those teams. This process can occur at any level in the hierarchy.

In general, data flows up the hierarchy, while directives down the hierarchy. In both flows, the level of detail increases towards the base of the hierarchy and decreases toward the root. For example, detailed data is captured in a robot in team T7. A summary of the data is shared with team T7 member robots using intra-team messages. The T7's team leader 50 regularly complies and summarizes data acquired from “private” intra-team messaging and publishes an inter-team message (to T5). The “public” inter-team message has less detail, but greater scope, than the inter-team messages exchanged between the member of T7. The team T5 team leader 50 reads T7's inter-team message and may incorporate it into T5 intra-team messages, and inter-team messages sent to T2. In a similar vein, directives become more detailed and less general as they flow down the hierarchy. A directive issued by T2's team leader and sent to team T5 will be interpreted by T5's team leader. The team leader will determine what specific actions must be accomplished to satisfy the T2 directive. As a result more specific directives are issued at the T5 level and dispatched to T5 members (as intra-team messages) and to teams T7 and T8 (as inter-team messages). The team leaders in T7 and T8 interpret the T5 directives, adding in the further detail needed to accomplish T2's initial directive. Each step down the hierarchy adds value (detail) to the initial directive.

An important aspect of successful operation and scalability is containment of information at appropriate levels in the hierarchy. Information needed by an individual robot to operate is often not useful for team operation. This type of information should never be passed in an intra-team message, but rather should be maintained locally in the robot. The same principal applies to information transmission between child and parent teams in the hierarchy. This keeps information where it is needed and reduces communication traffic, yet presents the base station with enough information to make informed decisions.

Heartbeats

Heartbeats can advantageously be used to ensure a robust system. They can, for example, be used to determine the presence (or more precisely, the non-absence) of a resource. For example, each resource (e.g. a team member) can issue heartbeat messages on a fixed schedule. The loss of a heartbeat (e.g. no heartbeat messages are received from a particular node over a given amount of time) can then be treated as the loss of the resource associated with that heartbeat message. Two representative classes of heartbeat are:
Team members generate heartbeat messages that are monitored by their peers; and
Team leaders produce team heartbeat messages that are monitored by members of other (especially parent) teams

Here is an example of how a heartbeat may be used. Assume that Robot_1 is the leader of Robot_2's team, and that Robot_1's heartbeat message has not been received by Robot_2 in the last N seconds. Robot_2 assumes that Robot_1 is unable to participate in team activities. Consequently, Robot_1 is entered in the World Model as MIA (missing in action), and a new team leader is identified.

Command and Control Base Station

The base station 14 monitors and controls a hierarchy of robot teams 14. It also provides a display for monitoring overall activity, tools to configure robot teams prior to missions, and tools to debrief robot teams after a mission. It provides different views of activity, the area of operation, and organizational structure. The base station may be based on, and have communication capabilities of, a director layer platform.

In general, the base station 14 issues directives and commands, Directives are used to express system goals that the team(s) must achieve and to update world models (e.g. to change map information). Directives use the Director-to-Director inter-node messaging mechanism. Commands are point-to-point communications whereby the base station 14 addresses the reflexive component (Executive 8) of a particular machine node. Commands are used to assume tele-operated control of a machine node. When the base station 14 is linked directly to the machine's reflex engine 28, the robot will follow the base station commands exactly. Usually, robots are not in tele-operation mode, in which case they are free to determine the best action to respond to a directive.

It is also possible to implement a tele-assisted operation. In this mode, a command is sent to the Director layer 6 and the machine will find the optimal set of actions required to accomplish this command. Command communications are synchronous and every message transmission expects a response, such as, for example, an ACK, NAK, or a timeout.

The base station 14 also manages the initialization of robots before a mission. This includes ensuring each robot has a current description of operational parameters, the organizational structure (teams, team membership, hierarchy), message routing rules, maps of the area of operation, default world model data, team- and self-goals and plan libraries. The base station is capable of debriefing robots after a mission (e.g. downloading on-board logs to support diagnostic and development activities, and/or and runtime statistics to support maintenance activities). The base station 14 can enable or disable logging of particular sensors during operations.

The embodiment(s) of the invention described above is(are) intended to be exemplary only. The scope of the invention is therefore intended to be limited solely by the scope of the appended claims.

We claim:

1. A control system for a mobile autonomous system, the control system comprising:
a generic controller platform including:
at least one microprocessor; and
a computer readable medium storing software implementing at least core functionality for controlling autonomous system; and
one or more user-definable libraries adapted to link to the generic controller platform so as to instantiate a machine node capable of exhibiting desired behaviours of the mobile autonomous system.

2. A control system as claimed in claim 1, wherein the machine node instantiated by the linked generic controller platform and user-definable libraries comprises:
a Director layer implementing high level reactive planning;
an Executive layer implementing sensor data processing and low level reflexive operations; and
a communications bus for mediating message flows between the Director layer an Executive layer processes.

3. A control system as claimed in claim 2, wherein processes of the Director layer and executive layer operate in respective different run-time environments.

4. A control system as claimed in claim 2, wherein the Director layer comprises;
at least one reasoning engine adapted for high-level reactive planning, and for generating director commands for execution be the executive layer; and
a dispatcher for managing message flows between the director layer and the executive layer.

5. A control system as claimed in claim 4, wherein the at least one reasoning engine comprises:
a team-OPRS adapted to maintain at least a world view and a listing of team-goals;
a self-OPRS adapted to update the world view based on state data received from the executive layer, and further to update a listing of self-goals based on team-goals recieved from the team-OPRS.

6. A control system as claimed in claim 5, wherein the self-OPRS is further operative to generate the director commands based on the listing of self-goals.

7. A control system as claimed in claim 2, wherein processes of the executive layer execute in a real-time environment.

8. A control system as claimed in claim 2, wherein the executive layer comprises:
a data path for deriving state data indicative of a state of the machine node, based on sensor data from one or more sensor publishing devices; and
a control path for generating actuator control signals based on director commands from the director layer processes and the state data.

9. A control system as claimed in claim 8, wherein the data path comprise:
an input interface for receiving sensor data from one or more sensor publishing devices;
a sensor fusion engine for processing the senor data to derive state data indicative of a state of the machine node; and
a state buffer for storing the state data.

10. A control system as claimed in claim 9, wherein the input interface comprises:
a physical interface;
one or more device driver components for controlling each sensor publishing device; and
one or more perception components for extracting sensor data from messages received by the input interface from each sensor publishing device.

11. A control system as claimed in claim 9, wherein the sensor fusion engine comprises any one or more of:
a Pre-filtering/Diagnostics sub-module;
a Filtering sub-module;
an Obstacle Detecton sub-module; and
a Gate Recognition sub-module.

12. A control system as claimed in claim 11, wherein the Pre-filtering/Diagnostics sub-module is operative to compare first sensor data from a first sensor publishing device with at least second sensor data from a second sensor publishing device, so as to identify errored sensor data.

13. A control system as claimed in claim 12, wherein the Pre-filtering/Diagnostics sub-module is further operative to compare the first sensor data with corresponding expected sensor data based on action commands related to low level actions taken by the machine node.

14. A control system as claimed in claim 11, wherein the Filtering sub-module implements a Kalman filter for estimating a state of the machine node based on the sensor data.

15. A control system as claimed in claim 11, wherein the Obstacle Detection sub-module is operative to detect objects within a predefined avoidance zone proximal the machine node, based on the sensor data.

16. A control system as claimed in claim 11, wherein the Obstacle Detection sub-module is operative to detect objects within a predefined stopping zone proximal the machine node, based on the sensor data.

17. A control system as claimed in claim 11, wherein the Gate Recognition sub-module is operative to detect a location and orientation of a gate, based on the sensor data.

18. A control system as claimed in claim 17, wherein the Gate Recognition sub-module is operative to:
examine each pair of objects detected within a vicinity of the machine node to identify pairs of objects having a predetermined size and separation distance, within respective predetermined tolerances;
examine each identified pair of objects to identify an object pair that is closest to an expected geographical location and orientation of the gate, based on world model information provided by the Director layer; and
calculate a gate signature for the identified object pair.

19. A control system as claimed in claim 18, wherein the gate signature is an n-dimensional vector representative of at least dimensions of the gate.

20. A control system as claimed in claim 8, wherein the control path comprises:
an executive engine responsive to director commands from the director layer, for determining low level actions to be taken by the machine node, and for generating corresponding low-level action commands;
a reflex engine for modifying the low-level action commands in accordance with at least the state data, and generate corresponding action commands; and
a device controller responsive to the action commands, for generating corresponding control signals for each of a plurality of actuators of the machine node.

21. A control system as claimed in claim 20, wherein the reflex engine comprises any one or more of:
a way-point navigation reflex;
an obstacle avoidance reflex; and
a gate crossing reflex.

22. A control system as claimed in claim 21, wherein the way-point navigation reflex comprises any one or more of:
a high level reflex for verifying that a current segment of a path has expired, and loading geographical coordinates of a next way-point of the path;
an Intermediate level reflex for determining a necessity of a consistent turn depending on an angle between two consecutive path segments and the current vehicle orientation, and for managing an angle of approach to a next segment depending on current lateral and heading offsets from the segment; and
a Low level reflex for generating corrective signals to turn the autonomous system depending on current estimations of the lateral and heading offsets from the next segment.

23. A control system as claimed in claim 21, wherein the Obstacle Avoidance reflex is operative for force a deviation of the path around an object detected within a predetermined avoidance zone in a vicinity of the autonomous system.

24. A control system as claimed in claim 23, wherein the Obstacle Avoidance reflex is operative to:
identify, from objects detected within the avoidance zone, a closest object to the autonomous system;
determining a manoeuvre for avoiding the identified closest object; and
forcing execution of the determined manoeuvre.

25. A control system as claimed in claim 21, wherein the Obstacle Avoidance reflex is operative for force a vehicle stop to prevent a collision between the autonomous system and an object detected within a predetermined stopping zone in a vicinity of the autonomous system.

26. A control system as claimed in claim 25, wherein the Obstacle Avoidance reflex is operative to:
detect, an object entering the stopping zone; and
issuing a vehicle stop command.

27. A control system as claimed in claim 1, wherein the generic controller platform further implements core functionality for communicating with other members of a team of robots.

28. A control system as claimed in claim 1, wherein the one or more user-definable libraries implement a structured format for defining data components, device drivers, and logic governing behaviours of the autonomous system.

29. In a control system for a mobile autonomous system, a method of detecting a gate comprising steps of:
examining each pair of objects detected within a vicinity of the autonomous system to identify pairs of objects having a predetermined size and separation distance, within respective predetermined tolerances;
examining each identified pair of objects to identify an object pair that is closest to an expected geographical location and orientation of the gate, based on world model information provided by the Director layer; and
calculating a gate signature for the identified object pair.

30. A method as claimed in claim 29, wherein the gate signature is an n-dimensional vector representative of at least dimensions of the gate.

31. In a control system for a mobile autonomous system, a method of avoiding an object, the method comprising steps of:
identifying, from objects detected within a predetermined avoidance zone of the autonomous system, a closest object to the autonomous system;
determining a manoeuvre for avoiding the identified closest object; and
forcing execution of the determined manoeuvre.
